(19) United States
(12) Patent Application Publication
(10) Pub. No.: US 2021/0218772 A1
(43) Pub. Date: Jul. 15, 2021

(54) SECURITY CONFIGURATION ASSESSMENT OF NEWLY COMMISSIONED NETWORK HARDWARE DEVICES

(71) Applicant: Saudi Arabian Oil Company, Dhahran (SA)

(72) Inventor: Hussain Hashim Alhaddad, Dammam (SA)

(21) Appl. No.: 16/742,563

(22) Filed: Jan. 14, 2020

(51) Int. Cl. H04L 29/06; H04L 29/12; H04L 12/26

(52) U.S. Cl. CPC H04L 63/20; H04L 61/2007; H04L 63/08; H04L 43/0811; H04L 43/0817

(57) ABSTRACT

A system and method for determining and modifying a security configuration of a networking device. A computing device having access to instructions on non-transitory processor readable media that, when executed by the computing device, configure the computing device to recognize that a networking device has been connected to a network and brought online. The computing device is further configured to map device information of the networking device to a respective security policy, wherein the respective security policy includes criteria for securing the networking device. The computing device is further configured to determine that the respective security policy is not implemented on the networking device. The computing device is further configured to modify the security configuration of the networking device to implement the respective security policy on the networking device.

### FIELD OF THE DISCLOSURE

This patent disclosure relates generally to systems and methods for computer networking, and, more particularly, to security configuration assessment and implementation for hardware devices commissioned onto a network.

### BACKGROUND OF THE DISCLOSURE

The need for connectivity of computing devices is paramount for successful operations in enterprise environments, including large, mid-size, and small businesses. In addition to a plethora of end-user computing devices interacting in such environments, countless networking hardware devices are used to provide necessary and customized architectures to support interactivity. For example, gateways, routers, bridges, modems, wireless access points, switches, hubs, and repeaters can be used in various combinations to provide network bandwidth.

Unfortunately, computer networks of all sizes and types are vulnerable to cyberattack. Accordingly, cybersecurity measures and management thereof are regularly implemented to protect an organization's data against attack, damage or unauthorized access.

Despite implementations to improve security, unauthorized access to network resources remains a concern. This can be at least partly due to incomplete or untimely security assessments of network hardware devices. For example, a newly commissioned network hardware device, such as a network hardware device that is deployed to a corporate network, may not be assessed from a security perspective until a respective information technology (“IT”) security entity is assigned and performs a task to assess the security configuration of a newly commissioned device. The task directs the IT security entity to independently verify the security requirements of one or more network hardware devices, and to ensure that the device(s) have been accordingly and appropriately configured. The assigned task for the IT entity to verify the security requirements during a commissioning process has several significant implications with regard to business processes and operations. For example, the delay of receiving a task and performing it can negatively impact timing of the device's commissioning. Further, a significant amount of resources, including financial and human resources, are required to continually attend to a large number of newly commissioned network hardware devices. Moreover, commissioning network hardware devices and attending to security tasks associated therewith often occur during off-hours, such as on weekends and holidays, to avoid service interruption during business hours. This adds to overall costs associated with commissioning network hardware devices.

It is with respect to this background that the present disclosure is addressed.

### SUMMARY OF THE DISCLOSURE

According to one or more implementations consistent with the present disclosure, a system and method are disclosed for determining and modifying a security configuration of a networking device. A networking device is recognized by at least one processor that has been commissioned on a network. At least one processor maps device information of the networking device to a respective security policy, in which the respective security policy includes criteria for securing the networking device. At least one processor also determines that the respective security policy is not implemented on the networking device. The at least one processor reports or modifies the security configuration of the networking device to implement the respective security policy on the networking device.

In one or more implementations, the networking device is arranged to connect two or more networks and is further arranged to forward data packets from one of the two networks to the other of the two networks. In addition to connecting two or more networks together, a networking device can filter, isolate, route or process data to increase network efficiency and performance. Furthermore, the networking device can connect different types of networks using different types of network protocols.

Moreover, in one or more implementations the networking device is further arranged to optimize bandwidth among a plurality of connected computing devices.

In addition, one or more implementations of the present disclosure regards receiving, by at least one processor, the device information of the networking device. The device information includes an IP address, a device type, and a device model of the networking device.

In certain implementations, receiving the device information of the networking device is in response to a request, transmitted from the at least one processor to at least one computing device, for the device information of the networking device.

Moreover, in one or more implementations, recognizing that the networking device has been commissioned on a network comprises monitoring, by at least one processor, network devices inventories, including from information provided monitoring systems.

In addition, in one or more implementations, the at least one processor transmits a message to at least one computing device that the networking device is ready to be placed into production after the security configuration of the networking device has been modified.

In one or more implementations, the at least one processor maps the device information to a different security policy, wherein the different security policy includes different criteria for securing the networking device. Further, the at least one processor determines that the different security policy is not implemented on the networking device. Moreover, the at least one processor modifies the security configuration of the networking device to implement the different security policy on the networking device.

In one or more implementations, the received device information is encapsulated prior to being received.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawing figures illustrate exemplary embodiments and are not intended to be limiting of the present disclosure. Among the drawing figures, like references are intended to refer to like or corresponding parts.

FIG. 1 is a flow diagram showing a routine that illustrates a broad aspect of the present disclosure, in accordance with one or more embodiments.

FIG. 2 is a flow diagram illustrating details associated with certain steps illustrated in FIG. 1, in accordance with one or more embodiments of the present disclosure.

FIG. 3 is a simple block diagram showing modular steps associated with newly commissioned network hardware devices and decommissioned network hard ware devices, in accordance with one or more embodiments of the present disclosure.

FIG. 4 is a block diagram that shows an example hardware arrangement that operates for providing the systems and methods disclosed herein.

FIG. 5 shows an example of a computing device that can be used to implement the techniques described herein the present disclosure.

### DETAILED DESCRIPTION OF CERTAIN EMBODIMENTS ACCORDING TO THE DISCLOSURE

By way of overview and introduction, the present disclosure presents technical method(s) and system(s) for repeatedly assessing, reporting, and modifying security configurations of network hardware devices, including newly commissioned and decommissioned networking hardware devices. Timely installation and configuration of security requirements for new network hardware devices, for example, improves security and protection of assets, including in an enterprise. Commissioned network hardware that is not secure for lacking current security requirements, for example, is automatically recognized by at least one computing device (referred to herein, generally, as a “security configuration assessment tool”). The security configuration assessment tool takes action to either report or modify the security configuration of the network hardware before it is deployed in production for a significant period of time. This precludes the network hardware from being exploited for unauthorized and/or malicious use, such as from a cyberattack. Moreover, security configuration information regarding network hardware devices is provided in a timely manner, including for devices that are not suitably configured for current security, and enables corrective measures to be taken before exploitation can occur.

The present disclosure includes one or more modules that execute to instantly provide reporting of security assessments of newly commissioned network hardware devices. In addition, one or more modules are provided that operate to update respective security configurations of network hardware devices, such as to ensure and verify that current security patches, firmware versions, and other measures have been installed for proper security compliance.

Thus, the present disclosure provides a technical solution that enables organizations to assess and report/modify security configurations for new and existing network hardware devices that have been commissioned or are yet to be commissioned. In one or more implementations and as part of the commissioning process, information representing a network hardware device is added to a monitoring system or asset inventory, once the physical and logical commissioning is complete. The monitoring system can be leveraged to detect newly added network hardware devices automatically. Once detected, one computing device can be configured to capture relevant information regarding the newly added device, such as internet protocol (“IP”) address, device type (e.g., gateway, router, bridge, modem, wireless access point, etc.), device model, device owner, or other relevant information. Moreover, the computing device can be configured to encapsulate the captured data to be provided to a security configuration assessment tool. For example, a security configuration assessment tool can be configured to map information representing a network hardware device to one or more relevant security policies, generate a report or certification, which can be immediately shared with a responsible IT security entity, such as a device owner to act according to the report. The network hardware device(s) can either proceed to production or be suspended from being connected to the network, for example, depending upon whether the device is (or can be) properly configured. Thus, the present disclosure provides an improvement to management processes in connection with commissioning network hardware devices on a network and improves the cybersecurity posture of a data network.

As used herein, an “entity” can refer to a person, a device, or a combination of a person and a device. An entity's actions in accordance with the present disclosure can be in human form. Further, an entity's actions can be in virtual form, such as an entity using a computing device that is connected to one or more data communication networks to access and/or request access to a network-based resource. An entity's actions can include controlling a device remotely to perform some operation.

The teachings herein include systems and methods that support automatic IT processes in a network, including to handle unexpected and frequent changes regarding newly commissioned network hardware devices or newly decommissioned ones. Mechanisms provided herein can promptly initiate appropriate actions based on the type of event (commissioning/decommissioning), which can potentially result in a security risk. For example, newly deployed network hardware devices that are not properly secured from unauthorized activity and threats can be identified and modified to be compliant with a particular security configuration. Furthermore, decommissioned network hardware devices can be automatically identified, and various resources previously used thereby, such as licensed IP addresses, can be automatically released. Identifying decommissioned network hardware devices in accordance with the present application can save valuable resources that would otherwise be spent, for example, if such devices are not promptly recognized as being decommissioned. Thus, the timely and automatic alert and handling of decommissioned network hardware devices is particularly valuable for efficient utilization of human and technological resources.

The present disclosure provides solutions to challenges faced by network security analysts, including those regarding timely verification of newly deployed network hardware devices. More particularly, the teachings herein provide solutions to shortcomings associated with known change management processes, in which tasks to verify that network hardware devices meet security requirements are assigned, tracked and completed by one or more responsible IT security entities. New solutions are provided that enable organizations to assess security configurations of new network hardware devices after being commissioned. As part of the commissioning process or once physical and logical commissioning of a network hardware device is complete, for example, the device (or information representing the device) can be added to an asset inventory that is accessible by a monitoring system. Relevant data associated with the device, such as IP address, device type, device model, owner, or the like, can be collected and, thereafter, encapsulated and transmitted to one or more appropriate security configuration assessment tools. Further, the data can be mapped to one or more relevant security policies to assess compliance with the policies, to generate report(s), and/or to certify the network hardware device as compliant. Moreover, information regarding the device can be shared immediately with one or more responsible entities (device owner or IT security entity). As noted herein, the network hardware device can either continue its way to production or be suspended from being connected to the network.

Accordingly, the present disclosure provides solutions that include configuring a computing device (e.g., a security configuration assessment tool) to promptly and automatically assess security configurations of newly commissioned network hardware devices, including after such devices go live in production. Based on the assessment, the computing device can take appropriate actions seamlessly. For example, the security configuration assessment tool detects a newly commissioned network hardware device that is misconfigured in accordance with current security requirements. The security configuration assessment tool can identify the misconfiguration automatically to a network administrator, or the tool can automatically execute remediation processes.

In one or more implementations, one or more computing devices configured as a security configuration assessment tool execute one or more instructions that result in actions taken after a newly commissioned network hardware device goes live in production. In one or more implementations, the actions are triggered after the security configuration assessment tool receives information, such as from one or more devices that monitor when network hardware devices go into production, representing that the network hardware device is in production. Once the security configuration assessment tool is informed that a respective network hardware device is in production, the tool can be configured to monitor network hardware device for compliance with respective security policies, and/or whether the network hardware device gets decommissioned. In one or more implementations, a computing device is configured to automatically detect the existence of a newly commissioned network hardware device in production, such as by inspecting information associated with the device in an asset inventory and determining that the newly commissioned network hardware device is in production.

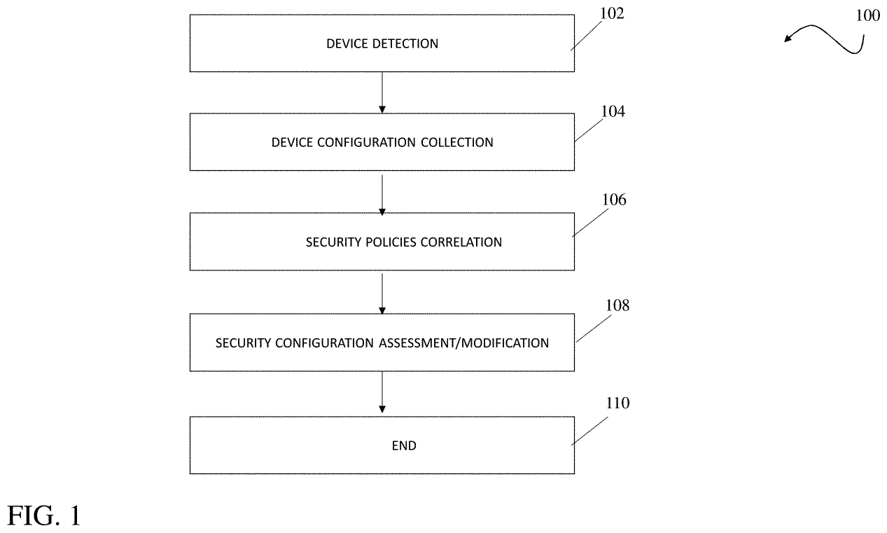

Turning now to FIG. 1, a flow diagram is described showing a routine 100 that illustrates a broad aspect of a method for security assessment and handling of newly commissioned network hardware devices, in accordance with one or more embodiments of the present disclosure. It is to be appreciated that several of the logical operations described herein are implemented as a sequence of computer-implemented acts or program modules running on one or more computing devices. Accordingly, the logical operations described herein are referred to variously as operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Continuing with reference to FIG. 1, the process begins at step 102 in which newly commissioned network hardware device(s) are detected by at least one computing device. For example, newly commissioned devices are detected and/or identified once they go live in production. In one or more implementations, information regarding the device(s) is properly documented, such as in one or more computing devices, for example, configured as a monitoring system. At step 104, configuration collection occurs, in which the security configuration assessment tool collects relevant configuration information based on previously gathered by and/or provided to the security configuration assessment tool. Thereafter, at step 106, the process continues, and the security configuration assessment tool correlates security configuration information associated with the device with security policies that are appropriate for the newly commissioned network hardware device. For example, information associated with a newly added device is mapped with information regarding relevant security policies for the respective device. The relevant security polices can be accessed or otherwise stored by the security configuration assessment tool and mapped to particulars associated with the respective network hardware device, such as internet IP address, device type, device model, device owner, or other relevant information.

Continuing with reference to FIG. 1, at step 108, a security configuration assessment tool applies information associated with steps associated with device configuration collection (step 104) and security policies correlation (step 106) to assess and/or modify the security configuration of one or more respective network hardware devices. For example, the security configuration assessment tool assesses the network hardware device and transmits information, such as in the form of one or more reports, an identified (or determined) IT security entity. The IT security entity can, for example, use the information to alter/update the security configuration of the respective network hardware device to bring the device into compliance with one or more appropriate policies. Alternatively (or in addition), the security configuration assessment tool applies information associated with steps 104 and 106 to modify the security configuration of the respective network hardware device(s). At step 110, the process ends.

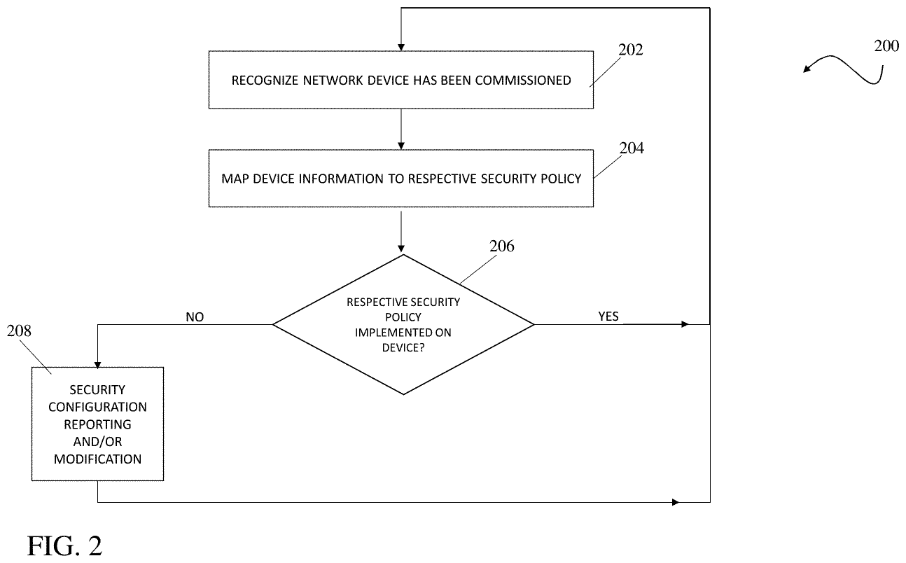

FIG. 2 is a flow diagram illustrating steps associated with an example implementation of the present disclosure. At step 202, a computing device, for example, configured to operate as a security configuration assessment tool, recognizes that a network hardware device has been commissioned on a network. Thereafter, the computing device maps information associated with the network hardware device to a respective security policy (step 204). At step 206, a determination is made whether the respective security policy mapped in step 204 is implemented on the network hardware device. If the result of the determination in step 206 is that the respective security policy is not implemented on the device, then the process branches to step 208 and the computing device reports that the respective security policy is not implemented on the network hardware device to a respective IT security entity, for example, that can take corrective action and alter the network hardware device's security configuration. In addition, or in the alternative, the computing device can cause corrective measures to be made automatically to implement the security policy on the network hardware device. Thereafter, the process loops back to step 202, and another network hardware device is recognized as having been commissioned, as the process continues.

Continuing with reference to FIG. 2, if the determination in step 206 is that the respective security policy is implemented on the network hardware device, then the process branches back to step 202, and another network hardware device is recognized as having been commissioned, as the process continues.

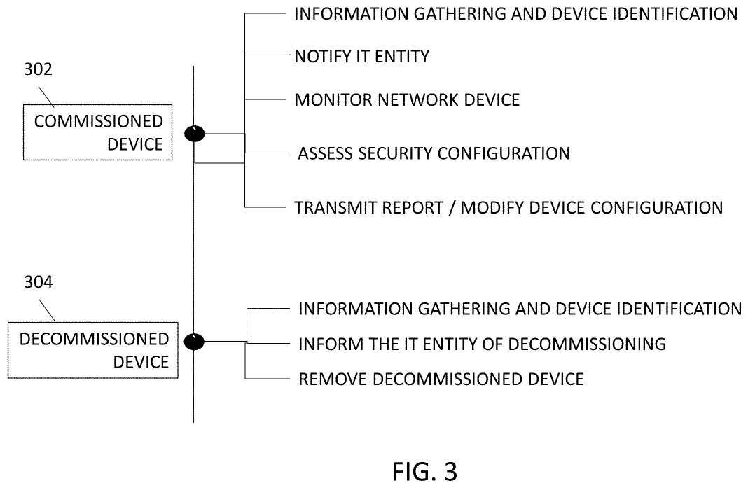

FIG. 3 is a simple block diagram showing modular steps associated with newly commissioned network hardware devices and decommissioned network hard ware devices, in accordance with one or more embodiments of the present disclosure. As shown and described herein, the present disclosure provides solutions to immediately and automatically assess the security configurations of newly commissioned network hardware device 302 or decommissioned network hardware devices 304. Various actions can be initiated automatically, for example, via a security configuration assessment tool, depending on a type the event (commissioning and/or decommissioning), as well as a respective state of a device 302,304. For example, and as illustrated in FIG. 3, in the event that a newly commissioned network hardware device 302 is detected, information gathering and asset identification can occur, automatically. For example, one or more computing devices configured to identify a newly added network hardware device can collect related information, such as device configuration information, for security verification. In addition, the one or more computing devices can inform a respective IT security entity after the network hardware device is commissioned, such as by transmitting a message via a suitable data communication protocol. The one or more computing devices (e.g., operating as a security configuration assessment tool) can monitor the newly commissioned network hardware device, including by receiving encapsulated information associated with the network hardware device and mapping the encapsulated information to corresponding security policies for assessment. In addition, the one or more computing devices can conduct a security assessment of the network hardware device. Other actions that can be taken include transmitting a report of findings to an IT security entity to act accordingly. Alternatively (or in addition), the one or more computing devices can take measures, automatically, to modify the security configuration of the network hardware device. Thereafter, the device can either continue its way to production or be suspended from being connected to the network.

Continuing with reference to FIG. 3, in the event that a newly decommissioned network hardware device 302 is detected, information gathering and asset identification can occur, automatically. For example, one or more computing devices can be configured to identify a newly decommissioned network hardware device. In addition, the one or more computing devices can inform a respective IT security entity after the network hardware device is decommissioned, such as by transmitting a message via a suitable data communication protocol. The one or more computing devices (e.g., operating as a security configuration assessment tool) can cease monitoring the respective network hardware device, and update records that the network hardware device is decommissioned.

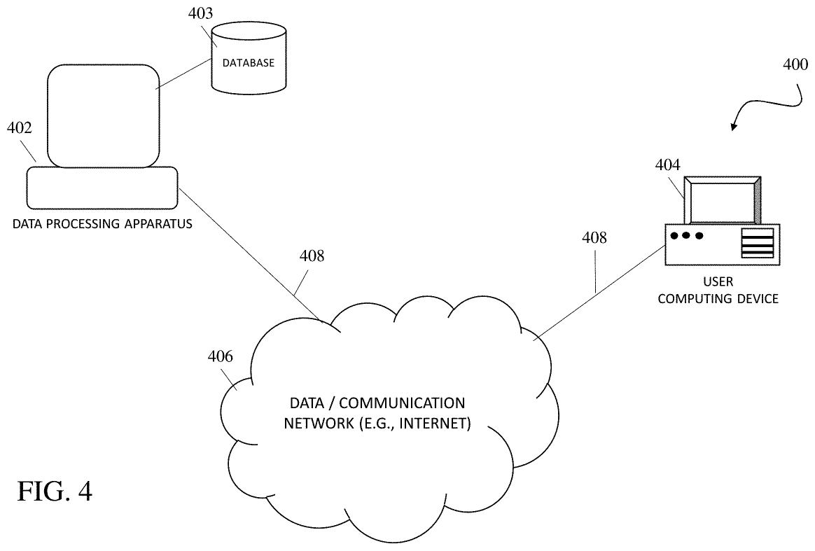

Referring to FIG. 4, a diagram is provided that shows an example hardware arrangement that operates for providing the systems and methods disclosed herein and designated generally as system 400. System 400 can include one or more information processors 402 that are at least communicatively coupled to one or more user computing devices 404 across communication network 406. Information processors 402 and user computing devices 404 can include, for example, mobile computing devices such as tablet computing devices, smartphones, personal digital assistants or the like, as well as laptop computers and/or desktop computers, server computers and mainframe computers. Further, one computing device may be configured as an information processor 402 and a user computing device 404, depending upon operations being executed at a particular time.

With continued reference to FIG. 4, information processor 402 can be configured to access one or more network devices databases 403 for the present disclosure, including source code repositories and other information. However, it is contemplated that information processor 402 can access the required network devices databases via communication network 406 or any other communication network to which information processor 402 has access. Information processor 402 can communicate with devices comprising databases using any known communication method, including a direct serial, parallel, universal serial bus (“USB”) interface, or via a local or wide area network.

User computing devices 404 can communicate with information processors 402 using data connections 408, which are respectively coupled to communication network 406. Communication network 406 can be any communication network, but typically is or includes the Internet or other computer network. Data connections 408 can be any known arrangement for accessing communication network 406, such as the public internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 404 preferably have the ability to send and receive data across communication network 406, and are equipped with web browsers, software disclosures, or other means, to provide received data on display devices incorporated therewith. By way of example, user computing device 404 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 406, and that wireless communication can be provided between wireless devices and information processors 402.

System 400 preferably includes software that provides functionality described in greater detail herein, and preferably resides on one or more information processors 402 and/or user computing devices 404. One of the functions performed by information processor 402 is that of operating as a web server and/or a web site host. Information processors 402 typically communicate with communication network 406 across a permanent i.e., un-switched data connection 408. Permanent connectivity ensures that access to information processors 402 is always available.

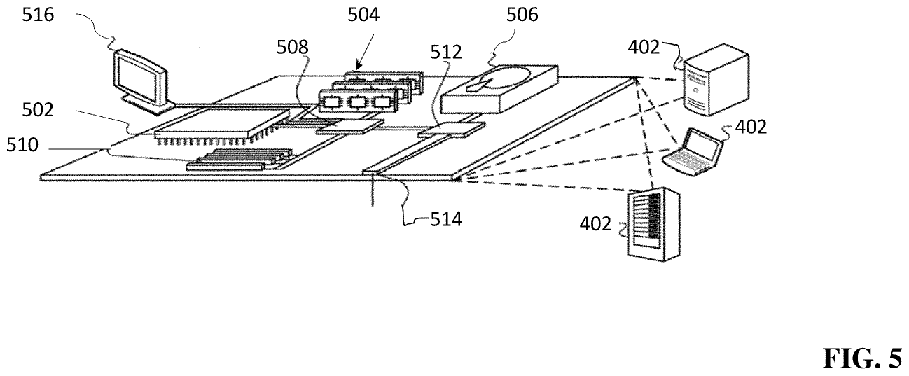

FIG. 5 shows an example information processor 402 that can be used to implement the techniques described herein. The information processor 402 is intended to represent various forms of digital computers, such as laptops, desktops, workstations, personal digital assistants, servers, blade servers, mainframes, and other appropriate computers. The components shown in FIG. 5, including connections and relationships, and their functions, are meant to be exemplary only, and are not meant to limit implementations of the inventions described and/or claimed in this document.

The information processor 402 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and can be mounted on a common motherboard or in other manners as appropriate. The processor 502 can process instructions for execution within the information processor 402, including instructions stored in the memory 504 or on the storage device 506 to display graphical information for a GUI on an external input/output device, such as a display 516 coupled to the high-speed interface 508. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 504 stores information within the information processor 402. In some implementations, the memory 504 is a volatile memory unit or units. In some implementations, the memory 504 is a non-volatile memory unit or units. The memory 504 can also be another form of computer-readable medium, such as a magnetic or optical disk.

The storage device 506 is capable of providing mass storage for the information processor 402. In some implementations, the storage device 506 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 504, the storage device 506, or memory on the processor 502.

The high-speed interface 508 can be configured to manage bandwidth-intensive operations, while the low-speed interface 512 can be configured to manage lower bandwidth-intensive operations. Of course, one of ordinary skill in the art will recognize that such allocation of functions is exemplary only. In some implementations, the high-speed interface 508 is coupled to the memory 504, the display 516 (e.g., through a graphics processor or accelerator), and to the high-speed expansion ports 510, which can accept various expansion cards (not shown). In an implementation, the low-speed interface 512 is coupled to the storage device 506 and the low-speed expansion port 514. The low-speed expansion port 514, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

As noted herein, the information processor 402 can be implemented in a number of different forms, as shown in the figure. For example, it can be implemented as a standard server, or multiple times in a group of such servers. In addition, it can be implemented in a personal computer such as a laptop computer. It can also be implemented as part of a rack server system. Alternatively, components from the computing device 200 can be combined with other components in a mobile device (not shown), such as a mobile computing device.

Thus, as shown and described herein, the present disclosure provides systems and methods that can operate to improve the security posture of, for example, a corporate data network. This can occur, for example, by utilizing the teachings herein for improved efficiency and utilization of resources. Further, the teachings herein eliminate previously needed security tools and communications, such as in connection with decommissioned network hard devices. Further, the number of hours that were previously used to unnecessarily maintain decommissioned network hardware devices are eliminated in accordance with the present disclosure. In addition, the teachings herein afford significant financial cost-savings, including by eliminating costs associated with software and IP address licenses, as only connected systems are monitored in accordance with teachings herein.

The terms “a,” “an,” and “the,” as used in this disclosure, means “one or more,” unless expressly specified otherwise.

The term “communicating device,” as used in this disclosure, means any hardware, firmware, or software that can transmit or receive data packets, instruction signals or data signals over a communication link. The hardware, firmware, or software can include, for example, a telephone, a smart phone, a personal data assistant (PDA), a smart watch, a tablet, a computer, a software defined radio (SDR), or the like, without limitation.

The term “communication link,” as used in this disclosure, means a wired and/or wireless medium that conveys data or information between at least two points. The wired or wireless medium can include, for example, a metallic conductor link, a radio frequency (RF) communication link, an Infrared (IR) communication link, an optical communication link, or the like, without limitation. The RF communication link can include, for example, Wi-Fi, WiMAX, IEEE 802.11, DECT, 0G, 1G, 2G, 3G or 4G cellular standards, Bluetooth, or the like, without limitation.

The terms “computer” or “computing device,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a server farm, a computer cloud, or the like, or an array of processors, microprocessors, central processing units, general purpose computers, super computers, personal computers, laptop computers, palmtop computers, notebook computers, desktop computers, workstation computers, servers, or the like, without limitation.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, Wi-Fi, WiMAX, IEEE 802.11, DECT, 0G, 1G, 2G, 3G, 4G, or 5G cellular standards, Bluetooth, or the like.

The terms “transmission” and “transmit,” as used in this disclosure, refer to the conveyance of signals via electricity, acoustic waves, light waves and other electromagnetic emissions, such as those generated in connection with communications in the radio frequency (RF) or infrared (IR) spectra. Transmission media for such transmissions can include coaxial cables, copper wire and fiber optics, including the wires that comprise a system bus coupled to the processor.

The term “database,” as used in this disclosure, means any combination of software and/or hardware, including at least one disclosure and/or at least one computer. The database can include a structured collection of records or data organized according to a database model, such as, for example, but not limited to at least one of a relational model, a hierarchical model, a network model or the like. The database can include a database management system disclosure (DBMS) as is known in the art. The disclosure may include, but is not limited to, for example, any disclosure program that can accept connections to service requests from clients by sending back responses to the clients. The database can be configured to run the disclosure, often under heavy workloads, unattended, for extended periods of time with minimal human direction.

The terms “including,” “comprising” and variations thereof, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which can be configured to communicate data via a wireless and/or a wired communication medium. These networks can run a variety of protocols not limited to TCP/IP, IRC or HTTP.

The term “server,” as used in this disclosure, means any combination of software and/or hardware, including at least one disclosure and/or at least one computer to perform services for connected clients as part of a client-server architecture. As an example, the server disclosure can include, but is not limited to, a disclosure program that can accept connections to service requests from clients by sending back responses to the clients. The server can be configured to run the disclosure, often under heavy workloads, unattended, for extended periods of time with minimal human direction. The server can include a plurality of computers configured, with the disclosure being divided among the computers depending upon the workload. For example, under light loading, the disclosure can run on a single computer. However, under heavy loading, multiple computers can be required to run the disclosure. The server, or any if its computers, can also be used as a workstation.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The invention encompassed by the present disclosure has been described with reference to the accompanying drawings, which form a part hereof, and which show, by way of illustration, example implementations and/or embodiments. As such, the figures and examples above are not meant to limit the scope of the present disclosure to a single implementation, as other implementations are possible by way of interchange of some or all of the described or illustrated elements, without departing from the spirit of the present disclosure. Among other things, for example, the disclosed subject matter can be embodied as methods, devices, components, or systems.

Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Furthermore, it is recognized that terms used herein can have nuanced meanings that are suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter can be based upon combinations of individual example embodiments, or combinations of parts of individual example embodiments.

The foregoing description of the specific implementations will so fully reveal the general nature of the disclosure that others can, by applying knowledge within the skill of the relevant art(s) (including the contents of the documents cited and incorporated by reference herein), readily modify and/or adapt for various disclosures such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown of drawings are shown accordingly to one example and other dimensions can be used without departing from the present disclosure.

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described example implementations, and the invention is to be understood as being defined by the recitations in the claims which follow and structural and functional equivalents of the features and steps in those recitations.

What is claimed:

1. A method for determining and modifying a security configuration of a networking device, the method comprising:
recognizing, by at least one processor configured by executing code, that a networking device has been commissioned on the network;
mapping, by the at least one processor, device information of the networking device to a respective security policy, wherein the respective security policy includes criteria for securing the networking device;
determining, by the at least one processor, that the respective security policy is not implemented on the networking device; and
reporting or modifying, by the at least one processor, the security configuration of the networking device to implement the respective security policy on the networking device.

2. The method of claim 1, wherein the networking device is arranged to connect two networks and is further arranged to forward data packets from one of the two networks to the other of the two networks.

3. The method of claim 2, wherein the networking device is further arranged to optimize bandwidth among a plurality of connected computing devices.

4. The method of claim 1, wherein recognizing that the networking device has been commissioned on a network comprises:
receiving, by at least one processor, the device information of the networking device,
wherein the device information includes an IP address, a device type, and a device model of the networking device.

5. The method of claim 4, wherein receiving the device information of the networking device is in response to a request, transmitted from the at least one processor to at least one computing device, for the device information of the networking device.

6. The method of claim 1, wherein recognizing that the networking device has been commissioned on a network comprises:
monitoring, by at least one processor, network asset inventories.

7. The method of claim 1, further comprising:
transmitting, by the at least one processor, a message to at least one computing device that the networking device is ready to be placed into production after the security configuration of the networking device has been modified.

8. The method of claim 1, further comprising:
mapping, by the at least one processor, the device information to a different security policy, wherein the different security policy includes different criteria for securing the networking device,
determining, by the at least one processor, that the different security policy is not implemented on the networking device; and
reporting or modifying, by the at least one processor, the security configuration of the networking device to implement the different security policy on the networking device.

9. The method of claim 1, wherein the received device information is encapsulated in a format that is interpretable by the at least one processor, prior to being received.

10. A system for determining and modifying a security configuration of a networking device, the system comprising:
a computing device having access to instructions on non-transitory processor readable media that, when executed by the computing device, configure the computing device to:
recognize that a networking device has been commissioned on the network;
map device information of the networking device to a respective security policy, wherein the respective security policy includes criteria for securing the networking device;
determine that the respective security policy is not implemented on the networking device; and
report or modify the security configuration of the networking device to implement the respective security policy on the networking device.

11. The system of claim 10, wherein the networking device is arranged to connect two networks and is further arranged to forward data packets from one of the two networks to the other of the two networks.

12. The system of claim 11, wherein the networking device is further arranged to optimize bandwidth among a plurality of connected computing devices.

13. The system of claim 10, wherein recognizing that the networking device has been commissioned on a network comprises:
receiving the device information of the networking device,
wherein the device information includes an IP address, a device type, and a device model of the networking device.

14. The system of claim 13, wherein receiving the device information of the networking device is in response to a request, transmitted from the at least one processor to at least one computing device, for the device information of the networking device.

15. The system of claim 10, wherein recognizing that the networking device has been commissioned on a network comprises:
monitoring, by at least one processor, network asset inventories.

16. The system of claim 10, wherein the computing device has access to instructions on non-transitory processor readable media that, when executed by the computing device, further configure the computing device to:
transmit a message to at least one computing device that the networking device is ready to be placed into production after the security configuration of the networking device has been modified.

17. The system of claim 10, wherein the computing device has access to instructions on non-transitory processor readable media that, when executed by the computing device, further configure the computing device to:
map the device information to a different security policy, wherein the different security policy includes different criteria for securing the networking device,
determine that the different security policy is not implemented on the networking device; and
report or modify the security configuration of the networking device to implement the different security policy on the networking device.

18. The system of claim 1, wherein the received device information is encapsulated in a format that is interpretable by the at least one computing device, prior to being received.
